(19) United States
(12) Patent Application Publication
(10) Pub. No.: US 2014/0352899 A1
(43) Pub. Date: Dec. 4, 2014

(54) Quick release window covering

(71) Applicant: Michele Alison Moolenbeek, Orleans (CA)

(72) Inventor: Michele Alison Moolenbeek, Orleans (CA)

(21) Appl. No.: 13/986,718

(22) Filed: May 29, 2013

(51) Int. Cl. E06B 9/24

(52) U.S. Cl. CPC E06B 9/24
USPC 160/368.1

(57) ABSTRACT

The Quick Release Window Covering is a simple window covering or blind unit devised to cover and thereby block visibility into a room from a hallway or similar adjoining spaces. This window covering is used primarily for lockdown procedures within schools; it can also be used in other facilities or institutions for isolating people for safety, security or privacy situations. The window covering emphasizes rapid release as this is critical for quickly protecting staff, students and visitors from volatile circumstances. The window covering is opaque, available in a choice of colors and medium weight. It is installed using an adhesive mounting strip across the top of the window opening and fits larger than the window opening to ensure the complete coverage of the transparent surface so no person can see into the space.

### CROSS REFERENCE TO RELATED APPLICATIONS

The application claims the benefit of Canadian Patent #2738841, filed on May 6, 2011 and issued on Jan. 15, 2013, the contents of which are hereby incorporated by reference in their entirety.

### FIELD OF THE INVENTION

The present invention relates generally to covering the visibility into a room within any facility or institution, for the security and protection of those inside said room.

### BACKGROUND OF THE INVENTION

### Quick Release Window Covering

Across the country, within each state, a key concern of the education system is the right to learn, work, and be present in a safe and secure environment. Simply stated, a safe school is a place where students can receive a high quality education without the threat of violence (Ref. 1). In a time of crisis, these concerns extend to ensuring that students, staff and visitors are exposed to as little risk as possible and there are mandatory protocols established in each jurisdiction for handling the circumstances which may arise. Certain situations warrant isolation as including, but are not limited to;
a student, staff, visitor or intruder who has become or is threatening to become violent inside the building.
person(s) outside the building intent on entering the building to cause harm.
   In these circumstances it would be safer for staff, students and visitors to stay secure inside a school room or facility room.

Interior windows are normally required into all rooms within a school environment as they allow for direct visibility and added safety for the people inside the room during normal operations. Also hidden spaces are not designed within a school for many security reasons. During certain emergency situations there is an identified need to have no visibility into the same room for a different security reason. These are different but equally important requirements within a school environment.

The mandatory protocol for situations in which a person or persons are threatening violence inside an educational building is to ensure that students, staff and visitors are isolated in a secured or “locked down” room within the facility. A critical factor in achieving an effective lockdown procedure is the ability to activate the security features of a room in as short a time as possible. The procedure for securing a room includes several key details such as locking any doors that provide access into the room and blocking visibility into the room through any windows, as it is known that an intruder typically will avoid rooms that they cannot get into and cannot see into. During lockdown situations, reaction time is critical. The mandatory lockdown drills are different between each state and or school board. Example: Utah State requires one lockdown drill per school year (Ref. 2).

There are currently concerns and problems that are related to blocking out the windows while securing a room for lockdown. A window is defined as any glazed opening which may be in a door, a sidelight, or in a wall. Most schools currently rely on paper products and tape to cover window openings. These items are readily available inside a school but not always within reach and affixed in a manageable timeframe. Even though everyone is in a crisis situation the window still must be covered with speed and accuracy.

There are specific requirements for a window covering during a lockdown procedure:
MUST be opaque (no shadows)
MUST cover entire window (no partial visibility)
MUST be quick to block window opening(s)
   Other features that would benefit a school or other facility when acquiring a window covering are:
EASY to install
MINIMAL maintenance
COST EFFECTIVE to allow schools to purchase units for every room
   A variety of window coverings exist. The following are some solutions that are currently being produced and sold by suppliers across the country:

### Mini Blinds/Venetian Blinds

These blinds have one mechanism to deploy the blind and a second mechanism to turn the blind closed, taking some time to use. They don't always completely block the view because of the holes in the slats that make up the blind and also the thickness of the mechanical header that is required to hold the blind in place. This can also cause gaps around the outside edge of the blind. Also they require tools and hardware to install. They are more expensive per unit to purchase and install. The controls of the blinds have added risks (strings, chain, etc) especially in a school setting. Due to the high number of parts these blinds can be easily damaged and are hard to keep clean. These blinds also require regular maintenance to ensure their functionality.

### Roller Blinds

Roller blinds are easier to deploy than mini or venetian blinds but do run the risk of springing back up if there is a mechanical failure. They don't always completely block the view because of the thickness of the mechanical header that is required to hold the blind in place. This can also cause gaps around the outside edge of the blind. They also require tools and hardware to install blind. They are more expensive per unit to purchase and install. These blinds are generally lightweight but can easily be damaged if not deployed properly. Requires less maintenance than mini or venetian blinds as they have fewer mechanical parts.

### Redi Shades

Redi Shades are a temporary blind that are not opaque and therefore do not cut out total visibility into a room. You can see shadows or movement. These blinds are a peel and stick installation and clothespins that are supplied with the unit are used to hold the blind up out of the way as they are not designed to stay furled. When deployed they do not lie flat over the window opening and do not block the view completely. They are fragile since they are made of paper and will deteriorate over time. A blind can be damaged very easily. Generally the lower quality of this blind makes it a temporary solution and they will have to be replaced regularly.

### BRIEF SUMMARY OF THE INVENTION

The Quick Release Window Covering is a new solution to this growing need of being secure inside any facility (schools or other institutions). It is a simple constructed blind solution which is fast and easily released with little effort, and lies flat in order to cover the entire window opening blocking out entire visibility from the outside of a room. There are minimal parts in the Quick Release Window Covering which reduces the risk of failure during critical situations. There is no mechanism or moving parts to deploy the blind. A light pulling action on the hold/release tabs releases the flat panel of opaque fabric to ensure the window opening is covered with minimal gaps ensuring no “see-thru” quality. This window covering is very cost efficient with minimal installation required. No tools or hardware are required for installation. There are no hanging parts or other features that can harm children. There is very little chance of the blind being easily damaged because of the durability and flexibility of the material used to create the window covering. This durability and flexibility increases the lifespan of the window covering. The Quick Release Window Covering is a new and simple solution that can be used where it is necessary to block visibility into a space, for safety, security or privacy situations.

This window covering is currently a vinyl fabric product that is opaque, medium weight, and has multiple hold/release tabs, that easily releases the window covering to fall and cover the window opening completely. The hold/release tabs keep the window covering in place out of the way until needed in a critical situation. Lengths of Velcro™ are used to mount the window covering and are used for the hold/release tabs. All Velcro™ pieces are sewn in place for durability. Velcro™ is the main component that enables the easy installation of this new window covering. The Quick Release Window Covering is basically maintenance free since the material is durable, flexible, and resistant to wear and damage. The window coverings are custom made to fit each window opening. The blinds come in a choice of color for aesthetics but also allows them to blend in with room decor. The color match to the room makes them unobtrusive and non-distracting when furled. When furled this reduces the urge for people to play with them.

### BRIEF DESCRIPTION OF THE DRAWINGS

FIG. 1 is a schematic front and back view of the Quick Release Window Covering embodying the invention and showing the installation of the invention permanently affixed to an interior door.

FIG. 2 is showing the position of the header mounting strip which is permanently affixed to an interior door.

FIG. 3 is showing the front view of the Quick Release Window Covering affixed to an interior door and in the furled position for storage.

FIG. 4 is showing the side view of the Quick Release Window Covering affixed to an interior door and in the furled position for storage.

FIG. 5 is showing the Quick Release Window Covering in three different openings options within a room. 1-A window within a door. 2-A window in a wall. 3-A door sidelight.

They show the furled and unfurled positions of the Quick Release Window Covering.

FIG. 6 is showing the side view of the Quick Release Window Covering in the furled positions on window openings.

FIG. 7 is showing the side view of the Quick Release Window Covering in the unfurled positions on window openings.

### DETAILED DESCRIPTION OF THE INVENTION

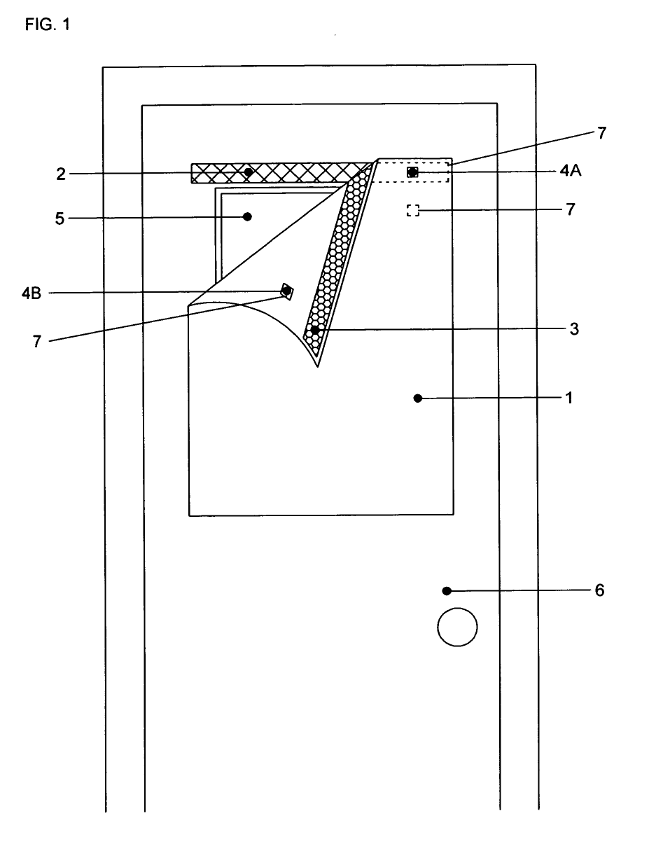

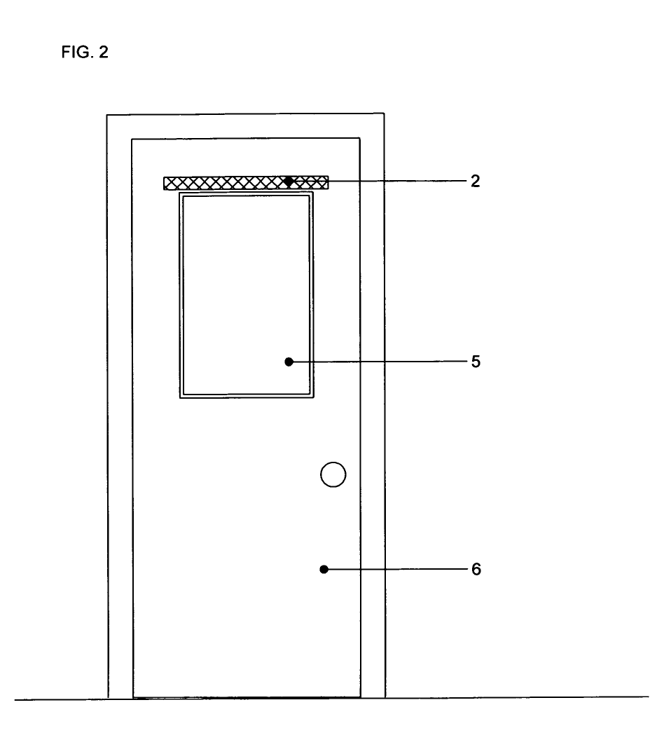

Production of the Quick Release Window Covering begins with the measurement of each window opening. The window covering panel is measured out to be moderately larger than a given window opening. The fabric is cut to be wider and longer than the window opening to ensure the complete coverage of the window opening and to minimize any gaps. A Velcro™ mounting strip is cut to correspond to the fabric width and then sewn to the top edge of the window covering panel on the wrong side of the fabric for installation purposes. This forms the first part of the header of the Quick Release Window Covering. (FIGS. 1A & 1B) The matching mate of the Velcro™, which has an adhesive backing on it, is measured and cut to fit the Velcro™ mounting strip which is attached to complete the header. (This adhesive Velcro™ mounting strip will be transferred and applied above the window opening at the time of installation. (FIG. 2))

The next step of production is where one piece of the hold/release tabs are cut and sewn to the header section on the blind, on the right side of the fabric and through the Velcro™ mounting strip. Note: Not through the adhesive Velcro™ mounting strip, it has been removed until the blind unit is complete. The matching pieces of the hold/release tabs are placed in coordinating positions just below the header and on the wrong side of the fabric. To confirm and mark the position of the hold/release tabs the blind is rolled into its furled position. Note: The number of hold/release tabs is dependent on the width of the window covering. The hold/release tabs are aligned to secure the window covering in place against the header when the blind is fully rolled up during normal operations. To test the alignment of the hold/release tabs the blind is rolled into its furled position again. The adhesive Velcro™ mounting strip is returned to the matching Velcro™ mounting strip on the window covering. The production of the individual blind is complete.

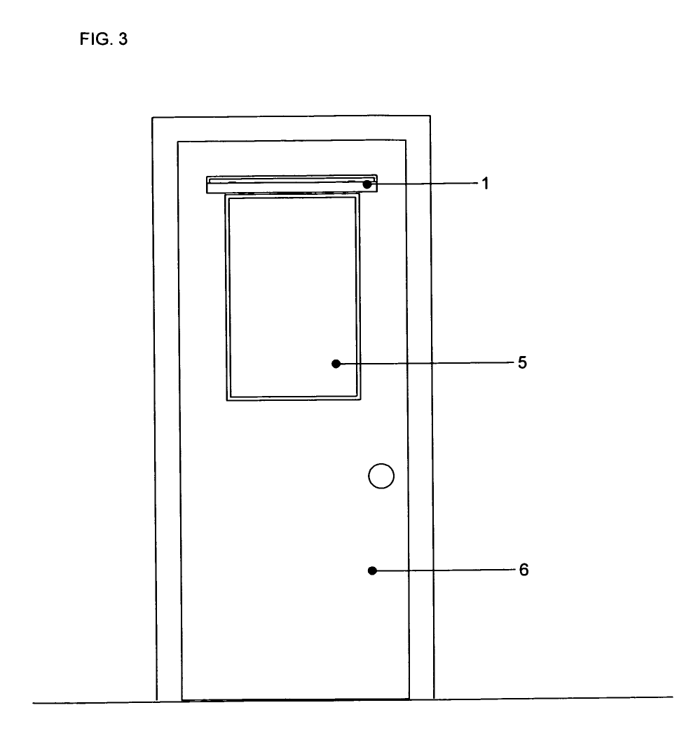

For installation of the completed blind, the adhesive Velcro™ mounting strip is separated from the header of the window covering and is leveled and centered above the window opening and adhered with manual pressure. (FIG. 2) The Quick Release Window Covering blind is then attached to the top of the window opening making sure the matching Velcro™ mounting strip align and adhere well to each other over the full width of the window covering blind. (FIG. 3)

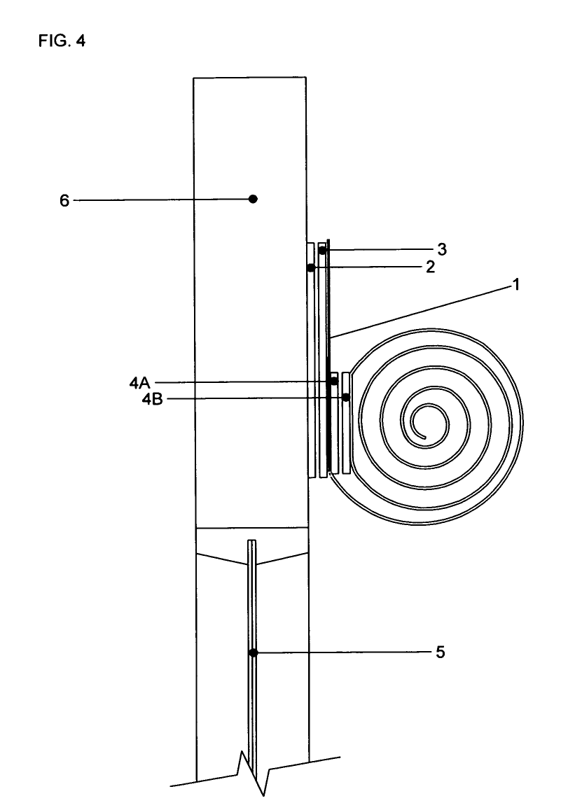

FIG. 4 shows the blind completely deployed/unfurled, covering the window opening during a real lockdown situation or a drill.

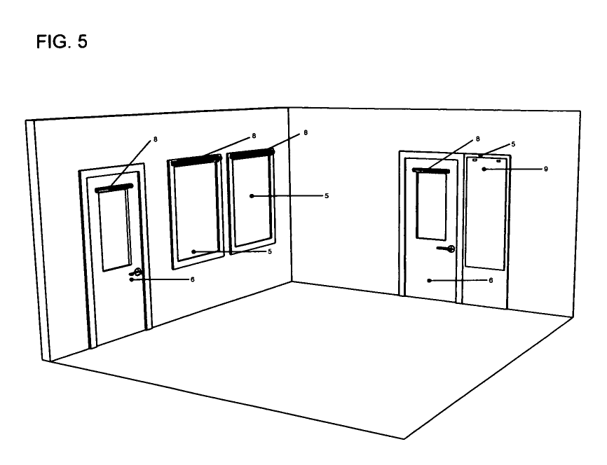

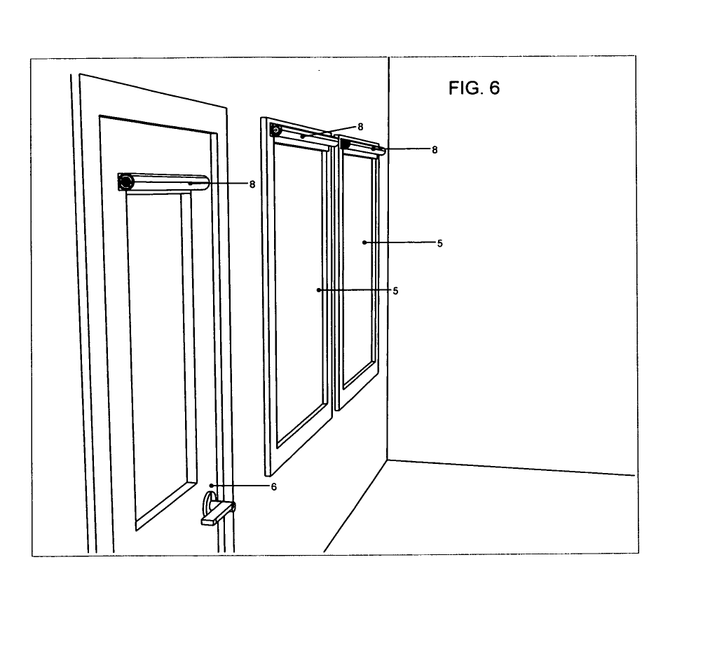

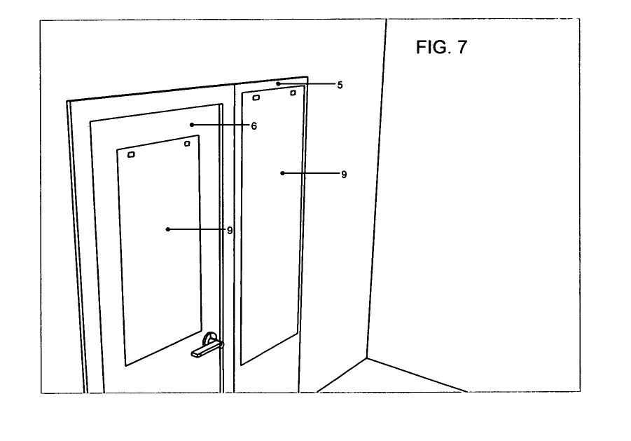

FIGS. 5, 6 and 7 show installation options with windows and doors that have the Quick Release Window Covering installed/furled over multiple window openings. One option illustrates the Quick Release Window Covering deployed/unfurled.

Other possible alternatives of the Quick Release Window Covering are:

1. Other suitable fabrics could be used as long as they are opaque and have some weight to them in order to lie flat against the window opening without leaving large gaps around the window opening.

2. Adding weight or a rod to the bottom of the fabric. This would help the fabric fall faster and lay flatter. It would also ease rolling the window covering back up.

3. Adding pulls or rip cords at the hold/release tabs on the front header for easier release. The length of the pulls or rip cords would be minimized to ensure they are reachable without excess length.

4. Using an alternative for the Velcro™ hold/release tabs would include, but not be limited to, magnets, sticky compound or other adhesion options.

5. Adding Velcro™ mounting strips or tabs on the bottom of covering panel and on the bottom of window opening, to hold the window covering more firmly in place. This would prevent the possibility of movement of the blind that might allow gaps and unwanted visibility into the secure space.

6. Using an alternative mounting option to the window opening. This would include, but not be limited to, the use of a rigid header placed on the surface at the top of the window opening that would be either glued, nailed or screwed during installation.

### REFERENCES

1. www.cde.state.co.us/cdeprevention/download/pdf/UCLA_violence_prevention.pdf CENTER FOR MENTAL HEALTH IN SCHOOLS AT UCLA. 2007 Revision Violence Prevention and Safe Schools (page 5)
2. www.rules.utah.gov/publicat/code/r277/r277-400.htm#T7 Utah Administrative Code, Rule R277-400 Emergency Response Training, R277-400-7 B. & E.

I claim:

1. A Quick Release Window Covering is the combination of an opaque covering panel, header mounting strips, and one or more hold/release tabs in which;
an opaque covering panel that is used unfurled to cover a given window opening and block visibility through that window,
a header mounting strip which serves as a mounting point for said opaque covering panel,
a matching mounting strip installed above a given window opening and where said opaque covering panel is attached, and
hold/release tabs that keep said opaque covering panel furled against said header for storage.

2. A Quick Release Window Covering in which said opaque covering panel is made of a vinyl material.

3. A Quick Release Window Covering recited in claim 2 in which the opaque covering panel are made of other opaque materials, including but not limited to all cloth fabric or other materials that can be rolled and unrolled.

4. A Quick Release Window Covering recited in claim 2 in which said opaque covering panel is made of translucent material (allowing for privacy rather than visual isolation).

5. A Quick Release Window Covering in which said header mounting strip is velcro on said opaque covering panel and said matching mounting strip is adhesive backed velcro at the top of a given window opening for installation.

6. A Quick Release Window Covering recited in claim 5 in which said header mounting strip and said matching mounting strip is a rigid mounting strip affixed to the top of a given window opening using nails, screws or other means.

7. A Quick Release Window Covering in which said hold/release tabs are velcro.

8. A Quick Release Window Covering recited in claim 7 in which magnets, sticky compound or other adhesion options are used for said hold/release tabs.

9. A Quick Release Window Covering recited in claim 1 in which said hold/release tabs have pulls or rip cords attached to them in order to facilitate easier deployment of the opaque covering panel.

10. A Quick Release Window Covering recited in claim 1 in which velcro strips or tabs are added to the lower edge of the opaque covering panel and on the bottom of a given window opening, to hold the opaque covering panel more firmly in place.

11. A Quick Release Window Covering recited in claim 10 in which magnets, sticky compound or other adhesion options are used to hold said opaque covering panel more firmly in place.

12. A Quick Release Window Covering recited in claim 1 in which one or more weights placed at the lower edge of said opaque covering panel to facilitate easier and faster deployment.

13. A Quick Release Window Covering recited in claim 1 in which a rod is attached to the lower edge of said opaque covering panel to facilitate easier furling.
